(19) United States
(12) Patent Application Publication
(10) Pub. No.: US 2026/0196938 A1
(43) Pub. Date: Jul. 9, 2026

(54) A FAN SYSTEM AND A METHOD OF OPTIMIZING EFFICIENCY IN A FAN SYSTEM

(71) Applicant: Zerro Power Systems Pte Ltd, Singapore (SG)

(72) Inventors: Sehat SUTARDJA, Las Vegas, NV (US); Krishnamoorthy RAVISHANKER, Singapore (SG); Sridharan Vijay KRISHNA, Singapore (SG)

(21) Appl. No.: 19/129,789

(22) PCT Filed: Nov. 14, 2023
(86) PCT No.: PCT/SG2023/050760

§ 371 Date: May 14, 2025

(30) Foreign Application Priority Data
Nov. 14, 2022 (SG) 10202260092Y

(51) Int. Cl. H02M 3/158

(52) U.S. Cl. CPC H02M 3/1584

(57) ABSTRACT

There is provided a fan system and a method of optimizing efficiency in a fan system, the fan system comprising, a first electrical fan comprising a first control module configured to control electrical power provided to the first electrical fan; and a second electrical fan comprising a second control module configured to control electrical power provided to the second electrical fan; wherein the first control module is further configured to measure one or more operational parameters of the first electrical fan, such that the electrical power provided to the second electrical fan is based on the one or more operational parameters of the first electrical fan, and such that a substantially equal amount of electrical power is provided to the first and second electrical fans.

### TECHNICAL FIELD

The present disclosure relates broadly to a fan system and a method of optimizing efficiency in a fan system.

### BACKGROUND

Dual fan systems with two cascading fans are typically used to achieve high airflow and longer throw based on the aerodynamic design of the fan blades.

Typically, in a dual fan system having an inlet fan and an outlet fan, the inlet fan and outlet fan are operated at different speeds. For example, the inlet fan may be run at a higher speed (e.g., about 31,000 revolutions per minute (RPM)) requiring a higher current (e.g., 2.0 amperes (A)), while the outlet fan may be run at a lower speed (e.g., about 24,000 RPM) requiring a lower current (e.g., about 0.6 A). The overall efficiency of such a configuration is poor, as most of the load is on the fan running at the higher speed. Consequently, the high load torque on the inlet fan may stress the bearings and shorten the operational lifespan of the fan.

Thus, there is a need for a fan system and a method of optimizing efficiency in a fan system that seek to address or alleviate at least one of the above problems.

### SUMMARY

In accordance with a first aspect of the present disclosure, there is provided a fan system comprising, a first electrical fan comprising a first control module configured to control electrical power provided to the first electrical fan; and a second electrical fan comprising a second control module configured to control electrical power provided to the second electrical fan; wherein the first control module is further configured to measure one or more operational parameters of the first electrical fan, such that the electrical power provided to the second electrical fan is based on the one or more operational parameters of the first electrical fan, and such that a substantially equal amount of electrical power is provided to the first and second electrical fans.

In the fan system of the present disclosure, the first electrical fan and second electrical fan may be electrically connected to a power supply configured to provide electrical power to both the first and second electrical fans.

In the fan system of the present disclosure, the first electrical fan may be electrically connected to a first power supply configured to provide electrical power to the first electrical fan; and the second electrical fan may be electrically connected to a second power supply configured to provide electrical power to the second electrical fan.

In the fan system of the present disclosure, the first electrical fan may be an inlet fan proximal to an air inlet of the fan system, and the second electrical fan may be an outlet fan proximal to an air outlet of the fan system.

In the fan system of the present disclosure, the first electrical fan may be an outlet fan proximal to an air outlet of the fan system, and the second electrical fan may be an inlet fan proximal to an air inlet of the fan system.

In the fan system of the present disclosure, the first electrical fan and second electrical fan may be axially aligned such that respective axes of rotation of the first and second electrical fans lie along the same line.

In the fan system of the present disclosure, the electrical power may be supplied to respective motors of the first electrical fan and second electrical fan.

In the fan system of the present disclosure, the second control module may be configured to dynamically adjust the electrical power provided to the second electrical fan in response to changes in the electrical power provided to the first electrical fan.

In the fan system of the present disclosure, the first electrical fan may further comprise one or more sensors electrically connected to the first control module, said one or more sensors comprising one or more sensing elements positioned proximal to the first electrical fan for measuring the one or more operational parameters thereof.

In the fan system of the present disclosure, the first electrical fan may further comprise one or more sensors electrically connected between the first control module and the first electrical fan for measuring the one or more operational parameters thereof.

In accordance with a second aspect of the present disclosure, there is provided a method of optimizing efficiency in a fan system, the method comprising, providing a first electrical fan comprising a first control module configured to control electrical power provided to the first electrical fan; providing a second electrical fan comprising a second control module configured to control electrical power provided to the second electrical fan; measuring one or more operational parameters of the first electrical fan; and providing electrical power to the second electrical fan based on the one or more operational parameters of the first electrical fan, such that a substantially equal amount of electrical power is provided to the first and second electrical fans.

In the method of the present disclosure, the method may further comprise electrically connecting the first electrical fan and second electrical fan to a power supply configured to provide electrical power to both the first and second electrical fans.

In the method of the present disclosure, the method may further comprise electrically connecting the first electrical fan to a first power supply configured to provide electrical power to the first electrical fan; and electrically connecting the second electrical fan to a second power supply configured to provide electrical power to the second electrical fan.

In the method of the present disclosure, the first electrical fan may be an inlet fan proximal to an air inlet of the fan system, and the second electrical fan may be an outlet fan proximal to an air outlet of the fan system.

In the method of the present disclosure, the first electrical fan may be an outlet fan proximal to an air outlet of the fan system, and the second electrical fan may be an inlet fan proximal to an air inlet of the fan system.

In the method of the present disclosure, the method may further comprise axially aligning the first electrical fan and second electrical fan such that respective axes of rotation of the first and second electrical fans lie along the same line.

In the method of the present disclosure, the electrical power may be supplied to respective motors of the first electrical fan and second electrical fan.

In the method of the present disclosure, the method may further comprise dynamically adjusting the electrical power provided to the second electrical fan in response to changes in the electrical power provided to the first electrical fan.

In the method of the present disclosure, the method may further comprise providing one or more sensors electrically connected to the first control module, said one or more sensors comprising one or more sensing elements positioned proximal to the first electrical fan for measuring the one or more operational parameters thereof.

In the method of the present disclosure, the method may further comprise providing one or more sensors electrically connected between the first control module and the first electrical fan for measuring the one or more operational parameters thereof.

### BRIEF DESCRIPTION OF THE DRAWINGS

Exemplary embodiments of the invention will be better understood and readily apparent to one of ordinary skill in the art from the following written description, by way of example only, and in conjunction with the drawings, in which:

FIG. 1 is a schematic block diagram of a fan system in an example embodiment.

FIG. 2 is a circuit diagram of a three phase fan system in an example embodiment.

FIG. 3 is a circuit diagram of a one phase fan system in an example embodiment.

FIG. 4 is a circuit diagram of a three phase fan system in another example embodiment.

FIG. 5 is a circuit diagram of a one phase fan system in another example embodiment.

FIG. 6 is a schematic flowchart illustrating a method of optimizing efficiency in a fan system in an example embodiment.

### DETAILED DESCRIPTION

Example, non-limiting embodiments may provide a fan system and a method of optimizing efficiency in a fan system.

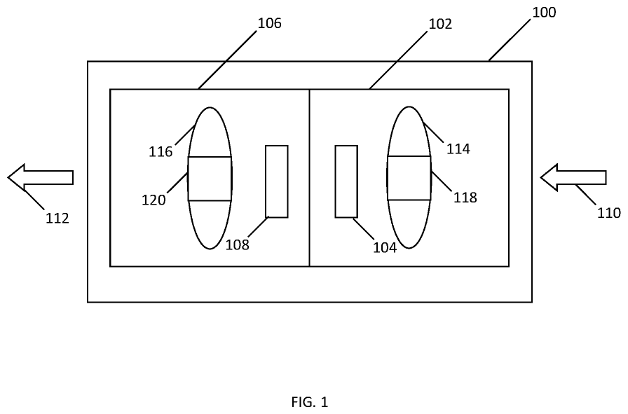

FIG. 1 is a schematic block diagram of a fan system 100 in an example embodiment.

15 In the example embodiment, the fan system 100 comprises a first electrical fan, e.g., inlet fan 102 comprising a first control module, e.g., inlet control module 104 configured to control electrical power provided to the first electrical fan 102, and a second electrical fan, e.g., outlet fan 106 comprising a second control module, e.g., outlet control module 108 configured to control electrical power provided to the second electrical fan 106. The first control module 104 is further configured to measure one or more operational parameters of the first electrical fan 102, such that the electrical power provided to the second electrical fan 106 is based on the one or more operational parameters of the first electrical fan 102, and such that a substantially equal amount of electrical power is provided to the first and second electrical fans 102, 106.

In the example embodiment, the first electrical fan 102 and second electrical fan 106 are connected to a power supply configured to provide electrical power. In some example embodiments, the first electrical fan 102 and second electrical fan 106 are electrically connected to a single/common power supply configured to provide electrical power to both the first and second electrical fans 102, 106. In some example embodiments, the first electrical fan 102 is electrically connected to a first power supply configured to provide electrical power to the first electrical fan 102 and the second electrical fan 106 is electrically connected to a second power supply configured to provide electrical power to the second electrical fan 106. The first and second electrical fans 102, 106 may be configured to draw a substantially equal amount of electrical power from the power supply.

In the example embodiment, the term “substantially equal” as used herein refers to a first measurement/parameter that differs from a second measurement/parameter by a value less than about 10 percent, less than about 9 percent, less than about 8 percent, less than about 7 percent, less than about 6 percent, less than about 5 percent, less than about 4 percent, less than about 3 percent, less than about 2 percent, or less than about 1 percent. In the example embodiment, the electrical power provided to the first electrical fan 102 and second electrical fan 106 may be adjusted to be within a programmable range of, for example, ±10% or ±5% of each other.

In the example embodiment, the first electrical fan 102 is configured to function as a master/primary fan and the second electrical fan 106 is configured to function as a slave/secondary fan. The first electrical fan 102 and second electrical fan 106 are electrically coupled to each other. The first control module 104 acting as the master controller is configured to utilize the one or more operational parameters (e.g., rotational speed, amount of electrical power provided) of the first electrical fan 102 as reference parameters for setting operational parameters (e.g., rotational speed, amount of electrical power provided) of the second electrical fan 106. The second control module 108 acting as the slave controller is configured to receive signals from the first control module 104 regarding the operational parameters of the second electrical fan 106, e.g., rotational speed of the second electrical fan 106, electrical power to be provided to the second electrical fan 106. It would be appreciated that in general, rotational speed may be directly proportional to the amount of electrical power provided. The second control module 108 may be configured to dynamically control/adjust the electrical power provided to the second electrical fan 106 in response to changes in the electrical power provided to the first electrical fan 102. The first control module 104 may be configured to adjust the speed of the first electrical fan 102 (i.e., master fan) and the speed of the second electrical fan 106 (i.e., slave fan) such that the electrical power provided to the first electrical fan 102 and second electrical fan 106 is substantially equal. For example, when the rotational speed of the blades of the first electrical fan 102 is adjusted e.g., increased or decreased by a user, the first control module 104 is configured to adjust the rotational speed of the blades of the second electrical fan 106 accordingly, such that a substantially equal amount of electrical power is provided to the first and second electrical fans 102, 106.

In the example embodiment, the fan system 100 may further comprise one or more sensors for measuring the one or more operational parameters such as the rotational speeds and the power/current drawn by the first electrical fan 102. The first control module 104 may be coupled to the one or more sensors, and configured to utilize the measurements made by the one or more sensors as reference parameters for setting/determining the operational parameters, e.g., rotational speed of the blades of the second electrical fan 106, the amount of electrical power to be supplied/provided to the second electrical fan 106. Accordingly, the second control module 108 may be configured to control the electrical power provided to the second electrical fan 106 based on operational parameters set by the first control module 104.

In some embodiments, the sensors may be comprised within the first control module 104. In some embodiments, the first electrical fan 102 may further comprise one or more sensors electrically connected to the first control module 104, said one or more sensors comprising one or more sensing elements positioned proximal to the first electrical fan 102 for measuring the one or more operational parameters thereof. For example, the sensors comprising sensing elements positioned proximal to the electrical fan(s) may be configured to directly measure the rotational speed of the motor.

In some embodiments, the first electrical fan 102 may further comprise one or more sensors electrically connected between the first control module 104 and the first electrical fan 102 for measuring the one or more operational parameters thereof. For example, the sensors electrically connected between the first control module 104 and the first electrical fan 102 may be configured to measure the amount of electrical current or power drawn by the electrical fan(s) and the controller 110 may use these measurements to calculate the rotational speed of the motor(s).

It would be appreciated that the second control module 108 may also comprise one or more sensors as described above for measuring one or more operational parameters such as the rotational speeds and the power/current drawn by the second electrical fan 106. The operational parameters of the second electrical fan 106 may be used for providing additional feedback control to ensure that a substantially equal amount of electrical power is provided to the first and second electrical fans 102, 106.

In the example embodiment, the first electrical fan 102 functioning as the master fan refers to the inlet fan proximal to an air inlet of the fan system 100, and the second electrical fan 106 functioning as the slave fan refers to the outlet fan proximal to an air outlet of the fan system 100. However, it would be appreciated that in other example embodiments, the fan system may be reconfigured such that the first electrical fan functioning as the master fan refers to the outlet fan proximal to an air outlet of the fan system and the second electrical fan functioning as the slave fan refers to the inlet fan proximal to an air inlet of the fan system.

In the example embodiment, the first electrical fan 102 and second electrical fan 106 may be arranged in a cascaded manner. In the example embodiment, the first electrical fan 102 and second electrical fan 106 may be axially aligned such that respective axes of rotation of the first and second electrical fans 102, 106 lie along the same line. By axially aligning the first electrical fan 102 and second electrical fan 106, a longer throw or better airflow may advantageously be achieved. As shown in FIG. 1, the first electrical fan 102 and second electrical fan 106 may be arranged such that air moves into the fan system 100 via the first electrical fan 102 (see arrow 110) and exits the fan system 100 via the second electrical fan 106 (see arrow 112).

Advantageously, by having a load distributed substantially equally between the two electrical fans 102, 106, a higher efficiency and longer operational lifespan of the electrical fans 102, 106 may be achieved. The load refers to the airflow in an electrical fan. The higher the load, the more volume of air is being pushed through the electrical fan at a given time. For example, the first electrical fan 102 may be driven at a significantly lower current and more load may be transferred to the second electrical fan 106. Consequently, the overall efficiency at high load may be improved, and lower stress exerted on the first electrical fan 102 bearings may significantly improve its reliability.

In the example embodiments, the first electrical fan 102 may comprise blades, e.g., 114 configured to rotate upon provision of electrical power and the second electrical fan 106 may comprise blades, e.g., 116 configured to rotate upon provision of electrical power. In the example embodiment, the first electrical fan 102 may further comprise a first motor 118 and the second electrical fan 106 may further comprise a second fan motor 120. The first motor 118 and second motor 120 may be electric motors. In the example embodiment, the first motor 118 and second motor 120 are coupled to and configured to rotate the blades, e.g., 114 of the first electrical fan 102 and the blades e.g., 116 of the second electrical fan 106, respectively. In the example embodiment, electrical power is supplied to respective motors 118, 120 of the first electrical fan 102 and second electrical fan 106. The first motor 118 and second motor 120 may each comprise a rotor and stator. The first motor 118 and second motor 120 may each comprise a rotating shaft for rotating the first electrical fan 102 and second electrical fan 106, respectively. The rotating shaft of the first motor 118 and the rotating shaft of the second motor 120 may be substantially axially aligned, i.e., disposed along a straight line acting as a common axis of rotation. In the example embodiment, the two separate motors 118, 120 allow the first electrical fan 102 and second electrical fan 106 to operate independently of each other. The motor may include but is not limited to a single-phase motor or a three-phase motor. While one phase and three phase motors are commonly used, motors with other phases are also suitable. It would be appreciated that the construction of a motor, e.g., electric motor that converts electrical energy into mechanical energy to operate the fans by rotating the fan blades would be understood by a person skilled in the art and is not further described herein.

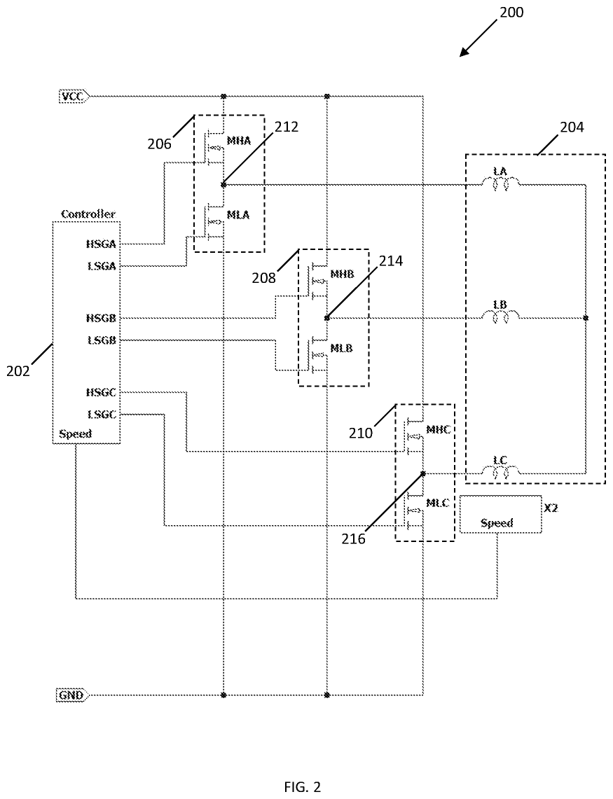

FIG. 2 is a circuit diagram of a three phase fan system 200 in an example embodiment.

The fan system 200 comprises a controller/control module 202 electrically coupled to a motor e.g., three-phase motor 204 of an electrical fan. For ease of illustration, FIG. 2 shows the controller 202 (compare 104, 108 of FIG. 1) electrically coupled to the motor of one electrical fan. This configuration may be applied in a similar manner to another electrical fan in a dual-fan system.

In the example embodiment, the three-phase motor 204 comprises three coils, i.e., a first coil LA, a second coil LB, and a third coil LC. Each coil is configured for receiving one phase of power for the three-phase motor 204. Collectively, the three coils LA, LB, LC are configured for receiving all three phases of power for the three-phase motor 204.

In the example embodiment, the controller 202 is electrically coupled to the three-phase motor 204 via a plurality of circuits. As shown in FIG. 2, the plurality of circuits comprises a first circuit 206, a second circuit 208, and a third circuit 210. Each circuit is electrically coupled to a corresponding coil to form a circuit and coil pair. That is, the controller 202 is electrically coupled to the three-phase motor 204 via a first circuit and coil pair comprising the first circuit 206 and the first coil LA, a second circuit and coil pair comprising the second circuit 208 and the second coil LB, and a third circuit and coil pair comprising the third circuit 210 and the third coil LC. The circuit is configured to provide electrical current of one phase to the corresponding coil which the circuit is electrically connected to. For example, the first circuit 206 and the corresponding first coil LA are electrically connected to each other. The first circuit 206 is configured to provide electrical current of one phase to the corresponding first coil LA. Collectively, the circuits 206, 208, 210 are configured for providing all three phases of power for the coils LA, LB, LC of the three-phase motor 204.

In the example embodiment, the circuits 206, 208, 210 comprise half-bridge circuits. In the example embodiment, the circuit comprises a first switch and a second switch connected in series, and a connection node between the first switch and the second switch. The first circuit 206 comprises a first switch MHA and a second switch MLA connected in series, and a connection node 212 between the first switch MHA and the second switch MLA. The second circuit 208 comprises a first switch MHB and a second switch MLB connected in series, and a connection node 214 between the first switch MHB and the second switch MLB. The third circuit 210 comprises a first switch MHC and a second switch MLC connected in series, and a connection node 216 between the first switch MHC and the second switch MLC.

In the example embodiment, the first switches MHA, MHB, MHC are high side switches, and the second switches MLA, MLB, MLC are low side switches. The high-side switch is connected between the positive supply voltage (VCC) and the coils (i.e., load). The high-side switch controls the current flow from the supply to the load and can be turned on and off to regulate the voltage or current to the load. The low-side switch is connected between the load and ground GND. The low-side switch controls the current path from the load to ground and can be used in conjunction with the high-side switch to regulate the current or voltage across the load. In the example embodiment, the first switch and second switch are metal-oxide-semiconductor field-effect transistors (MOSFETs). In the example embodiment, the first switch and second switch are n-channel MOSFETs. It would be appreciated that other transistors may be used in place of the MOSFETs.

In the example embodiment, the controller 202 comprises logic control means/circuit for controlling the operations of the circuits 206, 208, 210. The controller 202 comprises a high-side gate driver that is electrically coupled to the first switch, i.e., high-side switch, and a low-side gate driver that is electrically coupled to the second switch, i.e., low-side switch. As shown in FIG. 2, the controller 202 comprises a first high-side gate driver HSGA and a first low-side gate driver LSGA respectively coupled to the first switch MHA and second switch MLA of the first circuit 206; a second high-side gate driver HSGB and a second low-side gate driver LSGB respectively coupled to the first switch MHB and second switch MLB of the second circuit 208; and a third high-side gate driver HSGC and a third low-side gate driver LSGC respectively coupled to the first switch MHC and second switch MLC of the third circuit 210. In operation, each circuit e.g., 206 is configured by the control circuit comprised in the controller 202, to operate the switches e.g., MHA, MLA of the circuit 206, such that an alternating current supply is produced from the circuit e.g., 206 which is then delivered to the connected coil e.g., LA.

In the example embodiment, each coil e.g., LA comprises a first terminal, a second terminal, and a coiled section disposed between the first and second terminals. In the example embodiment, for each circuit electrically coupled to the corresponding coil, the connection node of the circuit is coupled to the first terminal of the coil via a power output terminal. The first coil LA comprises a first terminal electrically connected to the first circuit 206 at the connection node 212. The second coil LB comprises a first terminal electrically connected to the second circuit 208 at the connection node 214. The third coil LC comprises a first terminal electrically connected to the third circuit 210 at the connection node 216. In the example embodiment, the second terminals of the coils LA, LB, LC are electrically connected to share a common voltage level.

In the example embodiment, the fan system 200 further comprises a sensor X2 positioned proximal to the three phase motor 204 and electrically connected to the controller 202. The sensor X2 is configured to measure operational parameters of the three phase motor 204 (e.g. rotational speed) via one or more sensing elements and transmit the measured operational parameters of the three phase motor 204 to the controller 202. For example, the sensor X2 may be configured to directly measure the rotational speed of the three phase motor 204. The controller 202 is configured to utilize the measured rotational speed of the three phase motor 204 as reference parameters for setting operational parameters of an other three phase motor (not shown) that is connected to an other controller (not shown). In other words, the three phase motor 204 may be the motor of a master fan (compare first electrical fan 102 of FIG. 1) and the other three phase motor may be the motor of a slave fan (compare second electrical fan 106 of FIG. 1). The controller 202 may be the master controller of the master fan and the other controller may be the slave controller of the slave fan. It would be appreciated that the fan system 200 may further comprise an other sensor positioned proximal to the other three phase motor. Alternatively, the sensor X2 and/or its one or more sensing elements may be positioned such that it is proximal to both the three phase motor 204 and the other three phase motor. The controller 202 may comprise additional circuitry (not shown) and be configured to utilize the operational parameters measured by the sensor X2 to control the operation of the master and slave fans such that the electrical power provided to the slave fan is based on the operational parameters of the master fan, and such that a substantially equal amount of electrical power is provided to the master and slave fans.

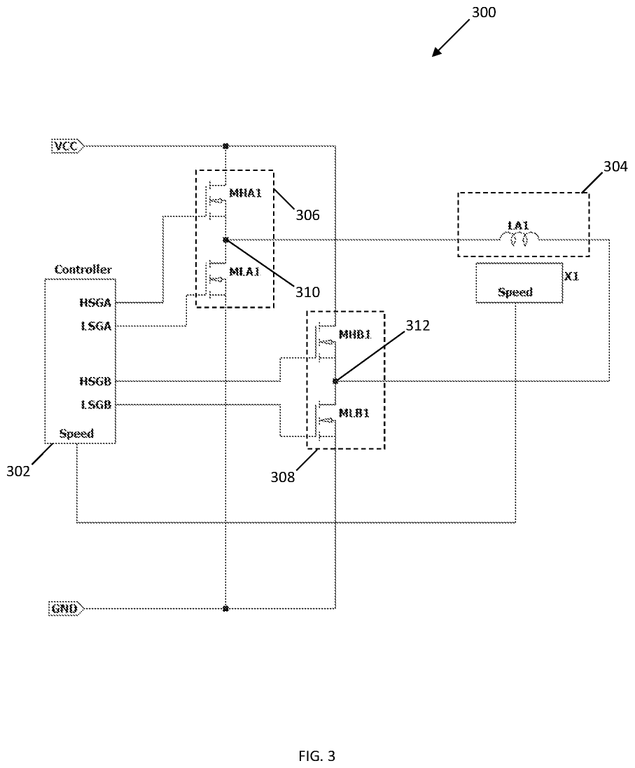

FIG. 3 is a circuit diagram of a one phase fan system 300 in an example embodiment.

The fan system 300 comprises a controller/control module 302 electrically coupled to a motor, e.g., single-phase motor 304. For ease of illustration, FIG. 3 shows the controller 302 (compare 104, 108 of FIG. 1) electrically coupled to the motor of one electrical fan. This configuration may be applied in a similar manner to another electrical fan in a dual-fan system.

In the example embodiment, the single-phase motor 304 comprises a coil LA1 configured for receiving power for the single-phase motor 304.

In the example embodiment, the controller 302 is electrically coupled to the single-phase motor 304 via a plurality of circuits. As shown in FIG. 3, the plurality of circuits comprises a first circuit 306 and a second circuit 308. The first circuit 306 is electrically coupled to a first terminal of the coil LA1. The second circuit 308 is electrically coupled to a second terminal of the coil LA1. The first circuit 306 and second circuit 308 are configured to provide electrical current to the corresponding coil LA1.

In the example embodiment, the first and second circuits 306, 308 comprise half-bridge circuits. In the example embodiment, the circuit comprises a first switch and a second switch connected in series, and a connection node between the first switch and the second switch. The first circuit 306 comprises a first switch MHA1 and a second switch MLA1 connected in series, and a connection node 310 between the first switch MHA1 and the second switch MLA1. The second circuit 308 comprises a first switch MHB1 and a second switch MLB1 connected in series, and a connection node 312 between the first switch MHB1 and the second switch MLB1.

In the example embodiment, the first switches MHA1, MHB1 are high side switches, and the second switches MLA1, MLB1 are low side switches. The high-side switch is connected between the positive supply voltage (VCC) and the coil LA1 (i.e., load). The high-side switch controls the current flow from the supply to the load and can be turned on and off to regulate the voltage or current to the load. The low-side switch is connected between the load and ground GND. The low-side switch controls the current path from the load to ground and can be used in conjunction with the high-side switch to regulate the current or voltage across the load. In the example embodiment, the first switch and second switch are metal-oxide-semiconductor field-effect transistors (MOSFETs). In the example embodiment, the first switch and second switch are n-channel MOSFETs. It would be appreciated that other transistors may be used in place of the MOSFETs.

In the example embodiment, the controller 302 comprises logic control means/circuit for controlling the operations of the circuits 306, 308. The controller 302 comprises a high-side gate driver that is electrically coupled to the first switch, i.e., high-side switch, and a low-side gate driver that is electrically coupled to the second switch, i.e., low-side switch. As shown in FIG. 3, the controller 302 comprises a first high-side gate driver HSGA and a first low-side gate driver LSGA respectively coupled to the first switch MHA1 and second switch MLA1 of the first circuit 306; and a second high-side gate driver HSGB and a second low-side gate driver LSGB respectively coupled to the first switch MHB1 and second switch MLB1 of the second circuit 308. In operation, each circuit e.g., 306 is configured by the control circuit comprised in the controller 302, to operate the switches e.g., MHA1, MLA1 of the circuit 306, such that an alternating current supply is produced from the circuit e.g., 306 which is then delivered to the connected coil e.g., LA1.

In the example embodiment, the coil LA1 comprises the first terminal, the second terminal, and a coiled section disposed between the first and second terminals. In the example embodiment, the connection node 310 of the first circuit 306 is coupled to the first terminal of the coil LA1 via a power output terminal. In the example embodiment, the connection node 312 of the second circuit 308 is coupled to the second terminal of the coil LA1 via a power output terminal.

In the example embodiment, the fan system 300 further comprises a sensor X1 positioned proximal to the one phase motor 304 and electrically connected to the controller 302. The sensor X1 is configured to measure operational parameters of the one phase motor 304 (e.g., rotational speed) via one or more sensing elements and transmit the measured operational parameters of the one phase motor 304 to the controller 302. For example, the sensor X1 may be configured to directly measure the rotational speed of the one phase motor 304. The controller 302 is configured to utilize the measured rotational speed of the one phase motor 304 as reference parameters for setting operational parameters of an other one phase motor (not shown) that is connected to an other controller (not shown). In other words, the one phase motor 304 may be the motor of a master fan (compare first electrical fan 102 of FIG. 1) and the other one phase motor may be the motor of a slave fan (compare second electrical fan 106 of FIG. 1). The controller 302 may be the master controller of the master fan and the other controller may be the slave controller of the slave fan. It would be appreciated that the fan system 300 may further comprise an other sensor positioned proximal to the other one phase motor. Alternatively, the sensor X1 and/or its one or more sensing elements may be positioned such that it is proximal to both the one phase motor 304 and the other one phase motor. The controller 302 may comprise additional circuitry (not shown) and be configured to utilize the operational parameters measured by the sensor X1 to control the operation of the master and slave fans such that the electrical power provided to the slave fan is based on the operational parameters of the master fan, and such that a substantially equal amount of electrical power is provided to the master and slave fans.

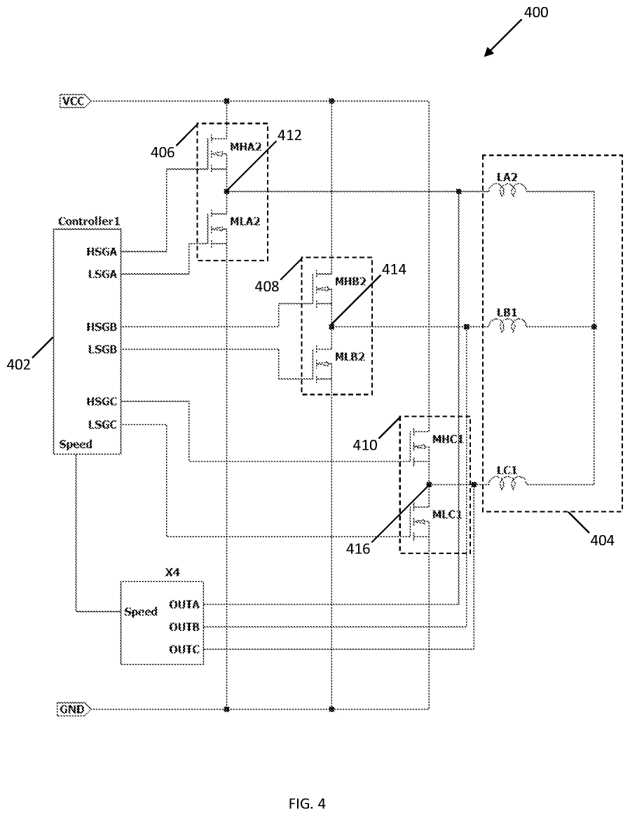

FIG. 4 is a circuit diagram of a three phase fan system 400 in another example embodiment.

The fan system 400 comprises a controller/control module 402 electrically coupled to a motor e.g., three-phase motor 404 of an electrical fan. For ease of illustration, FIG. 4 shows the controller 402 (compare 104, 108 of FIG. 1) electrically coupled to the motor of one electrical fan. This configuration may be applied in a similar manner to another electrical fan in a dual-fan system.

In the example embodiment, the three-phase motor 404 comprises three coils, i.e., a first coil LA2, a second coil LB1, and a third coil LC1. Each coil is configured for receiving one phase of power for the three-phase motor 404. Collectively, the three coils LA2, LB1, LC1 are configured for receiving all three phases of power for the three-phase motor 404.

In the example embodiment, the controller 402 is electrically coupled to the three-phase motor 404 via a plurality of circuits. As shown in FIG. 4, the plurality of circuits comprises a first circuit 406, a second circuit 408, and a third circuit 410. Each circuit is electrically coupled to a corresponding coil to form a circuit and coil pair. That is, the controller 402 is electrically coupled to the three-phase motor 404 via a first circuit and coil pair comprising the first circuit 406 and the first coil LA2, a second circuit and coil pair comprising the second circuit 408 and the second coil LB1, and a third circuit and coil pair comprising the third circuit 410 and the third coil LC1. The circuit is configured to provide electrical current of one phase to the corresponding coil which the circuit is electrically connected to. For example, the first circuit 406 and the corresponding first coil LA2 are electrically connected to each other. The first circuit 406 is configured to provide electrical current of one phase to the corresponding first coil LA2. Collectively, the circuits 406, 408, 410 are configured for providing all three phases of power for the coils LA2, LB1, LC1 of the three-phase motor 404.

In the example embodiment, the circuits 406, 408, 410 comprise half-bridge circuits. In the example embodiment, the circuit comprises a first switch and a second switch connected in series, and a connection node between the first switch and the second switch. The first circuit 406 comprises a first switch MHA2 and a second switch MLA2 connected in series, and a connection node 412 between the first switch MHA2 and the second switch MLA2. The second circuit 408 comprises a first switch MHB2 and a second switch MLB2 connected in series, and a connection node 414 between the first switch MHB2 and the second switch MLB2. The third circuit 410 comprises a first switch MHC1 and a second switch MLC1 connected in series, and a connection node 416 between the first switch MHC1 and the second switch MLC1.

In the example embodiment, the first switches MHA2, MHB2, MHC1 are high side switches, and the second switches MLA2, MLB2, MLC1 are low side switches. The high-side switch is connected between the positive supply voltage (VCC) and the coils (i.e., load). The high-side switch controls the current flow from the supply to the load and can be turned on and off to regulate the voltage or current to the load. The low-side switch is connected between the load and ground GND. The low-side switch controls the current path from the load to ground and can be used in conjunction with the high-side switch to regulate the current or voltage across the load. In the example embodiment, the first switch and second switch are metal-oxide-semiconductor field-effect transistors (MOSFETs). In the example embodiment, the first switch and second switch are n-channel MOSFETs. It would be appreciated that other transistors may be used in place of the MOSFETs.

In the example embodiment, the controller 402 comprises logic control means/circuit for controlling the operations of the circuits 406, 408, 410. The controller 402 comprises a high-side gate driver that is electrically coupled to the first switch, i.e., high-side switch, and a low-side gate driver that is electrically coupled to the second switch, i.e., low-side switch. As shown in FIG. 4, the controller 402 comprises a first high-side gate driver HSGA and a first low-side gate driver LSGA respectively coupled to the first switch MHA2 and second switch MLA2 of the first circuit 406; a second high-side gate driver HSGB and a second low-side gate driver LSGB respectively coupled to the first switch MHB2 and second switch MLB2 of the second circuit 408; and a third high-side gate driver HSGC and a third low-side gate driver LSGC respectively coupled to the first switch MHC1 and second switch MLC1 of the third circuit 410. In operation, each circuit e.g., 406 is configured by the control circuit comprised in the controller 402, to operate the switches e.g., MHA2, MLA2 of the circuit 406, such that an alternating current supply is produced from the circuit e.g., 406 which is then delivered to the connected coil e.g., LA2.

In the example embodiment, each coil e.g., LA2 comprises a first terminal, a second terminal, and a coiled section disposed between the first and second terminals. In the example embodiment, for each circuit electrically coupled to the corresponding coil, the connection node of the circuit is coupled to the first terminal of the coil via a power output terminal. The first coil LA2 comprises a first terminal electrically connected to the first circuit 406 at the connection node 412. The second coil LB1 comprises a first terminal electrically connected to the second circuit 408 at the connection node 414. The third coil LC1 comprises a first terminal electrically connected to the third circuit 410 at the connection node 416. In the example embodiment, the second terminals of the coils LA2, LB1, LC1 are electrically connected to share a common voltage level.

In the example embodiment, the fan system 400 further comprises a sensor X4 electrically connected between the controller 402 and the three phase motor 404. The sensor X4 is configured to indirectly measure operational parameters of the three phase motor 404 (e.g., rotational speed) by measuring back electromotive force (back EMF) in the three phase motor 304. Back EMF is measured indirectly by monitoring a voltage generated across the coils/windings of the three phase motor 404. The sensor X4 comprises a plurality of output terminals, each output terminal configured to electrically connect to a terminal of the coil of the three phase motor 404. As shown in FIG. 4, the sensor X4 comprises a first output terminal OUTA electrically connected to the first terminal of the first coil LA2, a second output terminal OUTB electrically connected to the first terminal of the second coil LB1, and a third output terminal OUTC electrically connected to the first terminal of the third coil LC1. The back EMF across the coils LA2, LB1 and LC1 are measured by the sensor X4 and transmitted to the controller 402. The controller 402 is configured to utilize the measured back EMF to calculate the rotational speed of the three phase motor 404. In general, the magnitude of a back EMF is proportional to the speed of a motor. The relationship between back EMF and speed is typically linear, with the proportionality constant determined by the motor's characteristics.

In the example embodiment, the controller 402 is further configured to utilize the calculated rotational speed of the three phase motor 404 as reference parameters for setting operational parameters of an other three phase motor (not shown) that is connected to an other controller (not shown). In other words, the three phase motor 404 may be the motor of a master fan (compare first electrical fan 102 of FIG. 1) and the other three phase motor may be the motor of a slave fan (compare second electrical fan 106 of FIG. 1). The controller 402 may be the master controller of the master fan and the other controller may be the slave controller of the slave fan. It would be appreciated that the fan system 400 may further comprise an other sensor electrically connected between the controller 402 and the other three phase motor. Alternatively, the sensor X4 may comprise additional connection terminals to electrically connect to the other controller and additional output terminals to electrically connect to the other three phase motor. The controller 402 may comprise additional circuitry (not shown) and be configured to utilize the operational parameters measured by the sensor X4 to control the operation of the master and slave fans such that the electrical power provided to the slave fan is based on the operational parameters of the master fan, and such that a substantially equal amount of electrical power is provided to the master and slave fans.

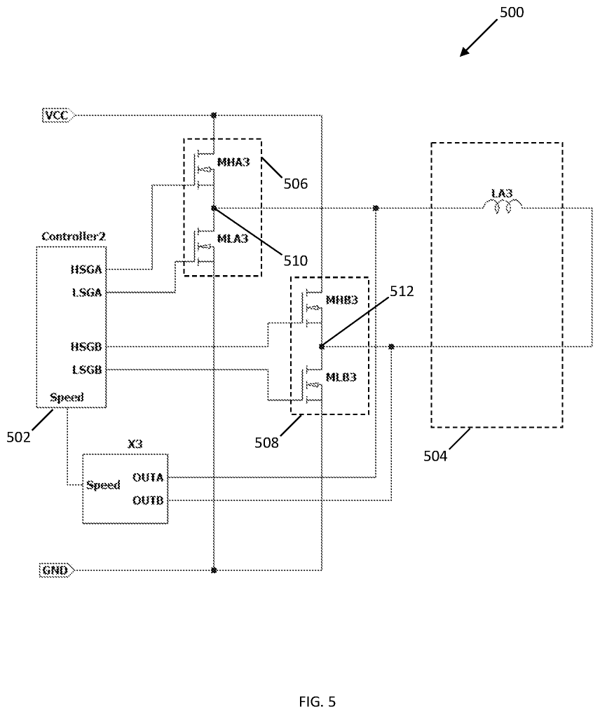

FIG. 5 is a circuit diagram of a one phase fan system 500 in an example embodiment.

The fan system 500 comprises a controller/control module 502 electrically coupled to a motor, e.g., single-phase motor 504. For ease of illustration, FIG. 5 shows the controller 502 (compare 104, 108 of FIG. 1) electrically coupled to the motor of one electrical fan. This configuration may be applied in a similar manner to another electrical fan in a dual-fan system.

In the example embodiment, the single-phase motor 504 comprises a coil LA1 configured for receiving power for the single-phase motor 504.

In the example embodiment, the controller 502 is electrically coupled to the single-phase motor 504 via a plurality of circuits. As shown in FIG. 5, the plurality of circuits comprises a first circuit 506 and a second circuit 508. The first circuit 506 is electrically coupled to a first terminal of the coil LA3. The second circuit 508 is electrically coupled to a second terminal of the coil LA3. The first circuit 506 and second circuit 508 are configured to provide electrical current to the corresponding coil LA3.

In the example embodiment, the first and second circuits 506, 508 comprise half-bridge circuits. In the example embodiment, the circuit comprises a first switch and a second switch connected in series, and a connection node between the first switch and the second switch. The first circuit 506 comprises a first switch MHA3 and a second switch MLA3 connected in series, and a connection node 510 between the first switch MHA3 and the second switch MLA3. The second circuit 508 comprises a first switch MHB3 and a second switch MLB3 connected in series, and a connection node 512 between the first switch MHB3 and the second switch MLB3.

In the example embodiment, the first switches MHA3, MHB3 are high side switches, and the second switches MLA3, MLB3 are low side switches. The high-side switch is connected between the positive supply voltage (VCC) and the coil LA3 (i.e., load). The high-side switch controls the current flow from the supply to the load and can be turned on and off to regulate the voltage or current to the load. The low-side switch is connected between the load and ground GND. The low-side switch controls the current path from the load to ground and can be used in conjunction with the high-side switch to regulate the current or voltage across the load. In the example embodiment, the first switch and second switch are metal-oxide-semiconductor field-effect transistors (MOSFETs). In the example embodiment, the first switch and second switch are n-channel MOSFETs. It would be appreciated that other transistors may be used in place of the MOSFETs.

In the example embodiment, the controller 502 comprises logic control means/circuit for controlling the operations of the circuits 506, 508. The controller 502 comprises a high-side gate driver that is electrically coupled to the first switch, i.e., high-side switch, and a low-side gate driver that is electrically coupled to the second switch, i.e., low-side switch. As shown in FIG. 5, the controller 502 comprises a first high-side gate driver HSGA and a first low-side gate driver LSGA respectively coupled to the first switch MHA3 and second switch MLA3 of the first circuit 506; and a second high-side gate driver HSGB and a second low-side gate driver LSGB respectively coupled to the first switch MHB3 and second switch MLB3 of the second circuit 508. In operation, each circuit e.g., 506 is configured by the control circuit comprised in the controller 502, to operate the switches e.g., MHA3, MLA3 of the circuit 506, such that an alternating current supply is produced from the circuit e.g., 506 which is then delivered to the connected coil e.g., LA3.

In the example embodiment, the coil LA3 comprises the first terminal, the second terminal, and a coiled section disposed between the first and second terminals. In the example embodiment, the connection node 510 of the first circuit 506 is coupled to the first terminal of the coil LA3 via a power output terminal. In the example embodiment, the connection node 512 of the second circuit 508 is coupled to the second terminal of the coil LA3 via a power output terminal.

In the example embodiment, the fan system 500 further comprises a sensor X3 electrically connected between the controller 502 and the one phase motor 504. The sensor X3 is configured to indirectly measure operational parameters of the one phase motor 504 (e.g., rotational speed) by measuring back electromotive force (back EMF) in the one phase motor 504. Back EMF is measured indirectly by monitoring a voltage generated across the coils/windings of the one phase motor 504. The sensor X3 comprises a plurality of output terminals, each output terminal configured to electrically connect to a terminal of the coil of the one phase motor 504. As shown in FIG. 5, the sensor X3 comprises a first output terminal OUTA electrically connected to the first terminal of the coil LA3, a second output terminal OUTB electrically connected to the second terminal of the coil LA3. The back EMF across the coil LA3 is measured by the sensor X3 and transmitted to the controller 502. The controller 502 is configured to utilize the measured back EMF to calculate the rotational speed of the one phase motor 504. In general, the magnitude of a back EMF is proportional to the speed of a motor. The relationship between back EMF and speed is typically linear, with the proportionality constant determined by the motor's characteristics.

In the example embodiment, the controller 502 is further configured to utilize the calculated rotational speed of the one phase motor 504 as reference parameters for setting operational parameters of an other one phase motor (not shown) that is connected to an other controller (not shown). In other words, the one phase motor 504 may be the motor of a master fan (compare first electrical fan 102 of FIG. 1) and the other one phase motor may be the motor of a slave fan (compare second electrical fan 106 of FIG. 1). The controller 502 may be the master controller of the master fan and the other controller may be the slave controller of the slave fan. It would be appreciated that the fan system 500 may further comprise an other sensor electrically connected between the controller 502 and the other one phase motor. Alternatively, the sensor X3 may comprise additional connection terminals to electrically connect to the other controller and additional output terminals to electrically connect to the other one phase motor. The controller 502 may comprise additional circuitry (not shown) and be configured to utilize the operational parameters measured by the sensor X3 to control the operation of the master and slave fans such that the electrical power provided to the slave fan is based on the operational parameters of the master fan, and such that a substantially equal amount of electrical power is provided to the master and slave fans.

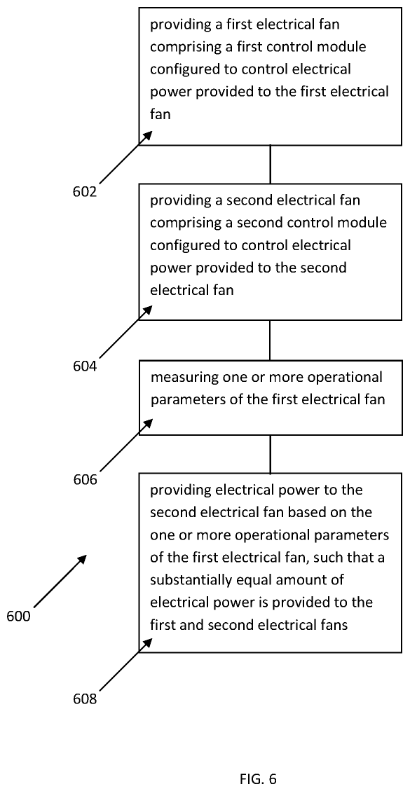

FIG. 6 is a schematic flowchart 600 illustrating a method of optimizing efficiency in a fan system in an example embodiment. At step 602, a first electrical fan is provided, said first electrical fan comprising a first control module configured to control electrical power provided to the first electrical fan. At step 604, a second electrical fan is provided, said second electrical fan comprising a second control module configured to control electrical power provided to the second electrical fan. At step 606, one or more operational parameters of the first electrical fan is measured. At step 608, electrical power is provided to the second electrical fan based on the one or more operational parameters of the first electrical fan, such that a substantially equal amount of electrical power is provided to the first and second electrical fans.

In some example embodiments, the method may further comprise electrically connecting the first electrical fan and second electrical fan to a power supply configured to provide electrical power to both the first and second electrical fans. In some example embodiments, the method may further comprise electrically connecting the first electrical fan to a first power supply configured to provide electrical power to the first electrical fan; and electrically connecting the second electrical fan to a second power supply configured to provide electrical power to the second electrical fan.

In some example embodiments, the first electrical fan may be an inlet fan proximal to an air inlet of the fan system, and the second electrical fan may be an outlet fan proximal to an air outlet of the fan system. In some example embodiments, the first electrical fan may be an outlet fan proximal to an air outlet of the fan system, and the second electrical fan may be an inlet fan proximal to an air inlet of the fan system.

In the example embodiment, the method may further comprise axially aligning the first electrical fan and second electrical fan such that respective axes of rotation of the first and second electrical fans lie along the same line.

In the example embodiment, the electrical power may be supplied to respective motors of the first electrical fan and second electrical fan. In the example embodiment, the method may further comprise dynamically adjusting the electrical power provided to the second electrical fan in response to changes in the electrical power provided to the first electrical fan.

In the example embodiment, the method may further comprise providing one or more sensors for measuring operational parameters such as the rotational speeds and the power/current drawn by the first and second electrical fans. In some example embodiments, the method may further comprise providing one or more sensors electrically connected to the first controller module, said one or more sensors comprising one or more sensing elements positioned proximal to the first electrical fan for measuring the one or more operational parameters thereof. In some embodiments, the method may further comprise providing one or more sensors electrically connected between the first controller module and the first electrical fan for measuring the one or more operational parameters thereof.

In the described example embodiments, the fan system, e.g., cooling fan, may be implemented in various applications, including but not limited to industrial systems, computer servers, automotive systems such as cars, car air-conditioners, car seat cooling systems, personal care products e.g., hairdryer, leisure and home/domestic appliances. In the described example embodiments, the fan system may advantageously provide relatively low noise and focused airflow.

The terms “coupled” or “connected” as used in this description are intended to cover both directly connected or connected through one or more intermediate means, unless otherwise stated.

The description herein may be, in certain portions, explicitly or implicitly described as algorithms and/or functional operations that operate on data within a computer memory or an electronic circuit. These algorithmic descriptions and/or functional operations are usually used by those skilled in the information/data processing arts for efficient description. An algorithm is generally relating to a self-consistent sequence of steps leading to a desired result. The algorithmic steps can include physical manipulations of physical quantities, such as electrical, magnetic or optical signals capable of being stored, transmitted, transferred, combined, compared, and otherwise manipulated.

The description also discloses relevant device/apparatus for performing the steps of the described methods. Such apparatus may be specifically constructed for the purposes of the methods, or may comprise a general purpose computer/processor or other device selectively activated or reconfigured by a computer program stored in a storage member. The algorithms and displays described herein are not inherently related to any particular computer or other apparatus. It is understood that general purpose devices/machines may be used in accordance with the teachings herein. Alternatively, the construction of a specialized device/apparatus to perform the method steps may be desired.

In addition, it is submitted that the description also implicitly covers a computer program, in that it would be clear that the steps of the methods described herein may be put into effect by computer code. It will be appreciated that a large variety of programming languages and coding can be used to implement the teachings of the description herein. Moreover, the computer program if applicable is not limited to any particular control flow and can use different control flows without departing from the scope of the invention.

Furthermore, one or more of the steps of the computer program if applicable may be performed in parallel and/or sequentially. Such a computer program if applicable may be stored on any computer readable medium. The computer readable medium may include storage devices such as magnetic or optical disks, memory chips, or other storage devices suitable for interfacing with a suitable reader/general purpose computer. In such instances, the computer readable storage medium is non-transitory. Such storage medium also covers all computer-readable media e.g., medium that stores data only for short periods of time and/or only in the presence of power, such as register memory, processor cache and Random Access Memory (RAM) and the like. The computer readable medium may even include a wired medium such as exemplified in the Internet system, or wireless medium such as exemplified in Bluetooth technology. The computer program when loaded and executed on a suitable reader effectively results in an apparatus that can implement the steps of the described methods.

The example embodiments including the controller or control modules e.g., 104, 108, 202, 302, 402, 502 may also be implemented as hardware modules. A module is a functional hardware unit designed for use with other components or modules. For example, a module may be implemented using digital or discrete electronic components, or it can form a portion of an entire electronic circuit such as an Application Specific Integrated Circuit (ASIC). A person skilled in the art will understand that the example embodiments can also be implemented as a combination of hardware and software modules.

Additionally, when describing some embodiments, the disclosure may have disclosed a method and/or process as a particular sequence of steps. However, unless otherwise required, it will be appreciated the method or process should not be limited to the particular sequence of steps disclosed. Other sequences of steps may be possible. The particular order of the steps disclosed herein should not be construed as undue limitations. Unless otherwise required, a method and/or process disclosed herein should not be limited to the steps being carried out in the order written. The sequence of steps may be varied and still remain within the scope of the disclosure.

Further, in the description herein, the word “substantially” whenever used is understood to include, but not restricted to, “entirely” or “completely” and the like. In addition, terms such as “comprising”, “comprise”, and the like whenever used, are intended to be non-restricting descriptive language in that they broadly include elements/components recited after such terms, in addition to other components not explicitly recited. For an example, when “comprising” is used, reference to a “one” feature is also intended to be a reference to “at least one” of that feature. Terms such as “consisting”, “consist”, and the like, may, in the appropriate context, be considered as a subset of terms such as “comprising”, “comprise”, and the like. Therefore, in embodiments disclosed herein using the terms such as “comprising”, “comprise”, and the like, it will be appreciated that these embodiments provide teaching for corresponding embodiments using terms such as “consisting”, “consist”, and the like. Further, terms such as “about”, “approximately” and the like whenever used, typically means a reasonable variation, for example a variation of +/−5% of the disclosed value, or a variance of 4% of the disclosed value, or a variance of 3% of the disclosed value, a variance of 2% of the disclosed value or a variance of 1% of the disclosed value.

Furthermore, in the description herein, certain values may be disclosed in a range. The values showing the end points of a range are intended to illustrate a preferred range. Whenever a range has been described, it is intended that the range covers and teaches all possible sub-ranges as well as individual numerical values within that range. That is, the end points of a range should not be interpreted as inflexible limitations. For example, a description of a range of 1% to 5% is intended to have specifically disclosed sub-ranges 1% to 2%, 1% to 3%, 1% to 4%, 2% to 3% etc., as well as individually, values within that range such as 1%, 2%, 3%, 4% and 5%. The intention of the above specific disclosure is applicable to any depth/breadth of a range.

In the described example embodiments, the system and method of optimizing efficiency in a fan system are described using two electrical fans for illustration purposes. It will be appreciated that the underlying concept behind the system and method of optimizing efficiency are not limited as such, and may be extended to a system and method of optimizing efficiency in more than two electrical fans. For example, the system and the associated method may further comprise a third electrical fan having blades configured to rotate upon provision of electrical power. The controller for controlling the provision of electrical power to the electrical fans may be configured such that the electrical power provided to the second and third electrical fan is based on the electrical power provided to the first electrical fan, such that a substantially equal amount of electrical power is provided to the first, second, and third electrical fans.

In the described example embodiments, the motors 204, 304, 404 and 504 are described to be coupled to a plurality of circuits comprising MOSFET switches. It will be appreciated that the motors in the presently disclosed system and method of optimizing efficiency in a fan system are not limited as such and may be driven by other means known to a person skilled in the art, depending on factors such as motor type, size, efficiency requirements and the desired level of control.

It will be appreciated by a person skilled in the art that other variations and/or modifications may be made to the specific embodiments without departing from the scope of the invention as broadly described. For example, in the description herein, features of different exemplary embodiments may be mixed, combined, interchanged, incorporated, adopted, modified, included etc. or the like across different exemplary embodiments. The present embodiments are, therefore, to be considered in all respects to be illustrative and not restrictive.

1. A fan system comprising,
a first electrical fan comprising a first control module configured to control electrical power provided to the first electrical fan; and
a second electrical fan comprising a second control module configured to control electrical power provided to the second electrical fan;
wherein the first control module is further configured to measure one or more operational parameters of the first electrical fan, such that the electrical power provided to the second electrical fan is based on the one or more operational parameters of the first electrical fan, and such that a substantially equal amount of electrical power is provided to the first and second electrical fans.

2. The fan system according to claim 1,
wherein the first electrical fan and second electrical fan are electrically connected to a power supply configured to provide electrical power to both the first and second electrical fans.

3. The fan system according to claim 1,
wherein the first electrical fan is electrically connected to a first power supply configured to provide electrical power to the first electrical fan; and
wherein the second electrical fan is electrically connected to a second power supply configured to provide electrical power to the second electrical fan.

4. The fan system according to claim 1,
wherein the first electrical fan is an inlet fan proximal to an air inlet of the fan system, and the second electrical fan is an outlet fan proximal to an air outlet of the fan system.

5. The fan system according to claim 1,
wherein the first electrical fan is an outlet fan proximal to an air outlet of the fan system, and the second electrical fan is an inlet fan proximal to an air inlet of the fan system.

6. The fan system according to claim 1,
wherein the first electrical fan and second electrical fan are axially aligned such that respective axes of rotation of the first and second electrical fans lie along the same line.

7. The fan system according to claim 1, wherein the electrical power is supplied to respective motors of the first electrical fan and second electrical fan.

8. The fan system according to claim 1, wherein the second control module is configured to dynamically adjust the electrical power provided to the second electrical fan in response to changes in the electrical power provided to the first electrical fan.

9. The fan system according to claim 1, wherein the first electrical fan further comprises one or more sensors electrically connected to the first control module, said one or more sensors comprising one or more sensing elements positioned proximal to the first electrical fan for measuring the one or more operational parameters thereof.

10. The fan system according to claim 1, wherein the first electrical fan further comprises one or more sensors electrically connected between the first control module and the first electrical fan for measuring the one or more operational parameters thereof.

11. A method of optimizing efficiency in a fan system, the method comprising,
providing a first electrical fan comprising a first control module configured to control electrical power provided to the first electrical fan;
providing a second electrical fan comprising a second control module configured to control electrical power provided to the second electrical fan;
measuring one or more operational parameters of the first electrical fan; and
providing electrical power to the second electrical fan based on the one or more operational parameters of the first electrical fan, such that a substantially equal amount of electrical power is provided to the first and second electrical fans.

12. The method according to claim 11,
further comprising electrically connecting the first electrical fan and second electrical fan to a power supply configured to provide electrical power to both the first and second electrical fans.

13. The method according to claim 11,
further comprising electrically connecting the first electrical fan to a first power supply configured to provide electrical power to the first electrical fan; and
electrically connecting the second electrical fan to a second power supply configured to provide electrical power to the second electrical fan.

14. The method according to claim 11,
wherein the first electrical fan is an inlet fan proximal to an air inlet of the fan system, and the second electrical fan is an outlet fan proximal to an air outlet of the fan system.

15. The method according to claim 11,
wherein the first electrical fan is an outlet fan proximal to an air outlet of the fan system, and the second electrical fan is an inlet fan proximal to an air inlet of the fan system.

16. The method according to claim 11,
further comprising axially aligning the first electrical fan and second electrical fan such that respective axes of rotation of the first and second electrical fans lie along the same line.

17. The method according to claim 11, wherein the electrical power is supplied to respective motors of the first electrical fan and second electrical fan.

18. The method according to claim 11, further comprising dynamically adjusting the electrical power provided to the second electrical fan in response to changes in the electrical power provided to the first electrical fan.

19. The method according to claim 11, further comprising providing one or more sensors electrically connected to the first control module, said one or more sensors comprising one or more sensing elements positioned proximal to the first electrical fan for measuring the one or more operational parameters thereof.

20. The method according to claim 11, further comprising providing one or more sensors electrically connected between the first control module and the first electrical fan for measuring the one or more operational parameters thereof.
